(19) United States
(12) Patent Application Publication
(10) Pub. No.: US 2023/0315128 A1
(43) Pub. Date: Oct. 5, 2023

(54) UNMANNED AERIAL VEHICLE EVENT RESPONSE SYSTEM AND METHOD

(71) Applicant: COLORBLIND ENTERPRISES, LLC, Manhattan Beach, CA (US)

(72) Inventor: Cletus Bradley, Manhattan Beach, CA (US)

(21) Appl. No.: 18/128,985

(22) Filed: Mar. 30, 2023

Related U.S. Application Data
(60) Provisional application No. 63/327,728, filed on Apr. 5, 2022.
(60) Provisional application No. 63/352,128, filed on Jun. 14, 2022.

(51) Int. Cl. G05D 1/10; B64U 10/13; B64U 70/93; G08G 5/00; G05D 1/12

(52) U.S. Cl. CPC G05D 1/106; B64U 10/13; B64U 70/93; G08G 5/003; G05D 1/12; G05D 1/104; G06Q 50/265

(57) ABSTRACT

A threat response system includes a response and alert generator to, based on one or more data feeds with event type data and event location data related to a surveilled area, classify an event, determine a total score of the event compared to a predetermined threat threshold, and output one or more response operations based on the event classification and the total score of the event. A response plan database is included to store and/or predict one or more predetermined action plans operable to direct one or more unmanned aerial vehicle (UAVs) to respond to the event. An event database is included to store a project of event types predetermined as suitable for a UAV response. A controller of the system can receive data from one or more data feeds associated with the surveilled area to determine a match between event data and one or more event types in the event database.

### CROSS-REFERENCE TO RELATED APPLICATIONS

This application claims the priority to and benefit under 35 U.S.C. § 119(e) of U.S. Provisional Patent Application No. 63/327,728, filed on Apr. 5, 2022, and U.S. Provisional Patent Application No. 63/352,128, filed on Jun. 14, 2022, each of which is hereby incorporated by reference in their entirety as if fully set forth below.

### FIELD

The present disclosure generally relates to security systems and methods that utilize unmanned air vehicles and mobile devices.

### BACKGROUND

In recent years, there has been a significant percent increase in the number of police officers assaulted and even killed in the line of duty. Unfortunately and for reasons unknown, only a small fraction of local law enforcement agencies even track officer misconduct. Regardless, in spite of the steady stream of unfortunate events in recent years related to police-associated citizen fatalities, the general public vastly supports law enforcement agencies. In particular, society at large recognizes the sacrifices that law enforcement personnel make, which are often overlooked and underappreciated. Moreover, police officers are often injured in the line of duty or get sick at the workplace. For example, the severe acute respiratory syndrome coronavirus 2 (SARS-CoV-2) (“COVID-19”) killed more police officers than all other causes combined in 2020. Accordingly, it would be desirous to provide a system to make police office and citizen safety a priority and reduce the incidence of assault (and even facilities) when law enforcement and citizens interact.

Relatedly, some security systems are known to output an alarm or a notification when an event occurs that requires attention, such as a typical car alarm. The notification can be a loud repetitive noise with the intention to draw attention and to deter a potential threat to the vehicle. However, for those situations where the repetitive noise becomes background noise and is neglected, immediate attention or deterrence wanes and the potential criminal is given the necessary opportunity to commit the crime. The criminal then leaves without a trace or a meaningful way of being identified. Accordingly, it would be desirous to provide a system to reduce the incidence of such threats and facilitate coordination with law enforcement.

It is with respect to these and other considerations that the various embodiments described below are presented.

### SUMMARY

Embodiments of the present disclosure include a threat response system and method for a vehicle is disclosed. The system includes a response and alert generator configured to classify an event by analyzing data from one or more data feeds comprising event type data and event location data related to a surveilled area, determine a total score of the event compared to a predetermined threat threshold, and output one or more response operations based on the event classification and the total score of the event. The system also includes a response plan database configured to store and/or predict one or more predetermined action plans operable to direct one or more unmanned aerial vehicle (UAVs) to respond to the event. The system may also include an event database and a controller. The event database is configured to store a plurality of event types predetermined as suitable for a UAV response. The controller can receive data from one or more data feeds associated with an event of the surveilled area, the data including the event type data and event location data. The controller can also classify the event by determining a match between a total score of the event compared with event data of the one or more data feeds and one or more event types in the event database, determine, based on the match, one or more UAV response operations, and cause the one or more UAVs to perform the one or more UAV response operations.

In some aspects, the one or more UAV response operations include one or more UAVs launching from a law enforcement vehicle to identify a citizen or a suspect associated with the event, causing the one or more UAVs to follow and/or distract the citizen or the suspect, alerting, by the one or more UAVs, one or more persons in a vicinity of the event regarding the event, and tracking and/or identifying, by the one or more UAVs, a location of a law enforcement officer in the vicinity of the event and/or guide the law enforcement officer to the event and/or the citizen or the suspect.

In some aspects, the controller is configured to share the data with a local network based on a determined geolocation calculated from the event location data, and use the local network as an information relay mesh that enhances communication of the one or more UAVs with a command center.

In some aspects, the controller is configured to receive data from one or more sensors installed on one or more UAVs and/or the surveilled area. Data from the one or more sensors may comprise a video feed, an audio data feed, a UAV location feed, a smart city component sensor feed, and/or a telemetry feed. Data from the one or more sensors may comprise a data feed of defined by data from one or more social media networks of user devices within a geofence associated with the event dynamically determined based on users with location-aware devices entering or exiting the geofence.

In some aspects, the controller is configured to receive data from one or more sensors installed on one or more UAVs and/or the surveilled area, wherein data from the one or more sensors comprise a facial recognition data feed.

In some aspects, the controller is configured to analyze event data of the one or more data feeds to determine the match by applying a machine learning system to identify one or more salient characteristics and apply a predictive score based on the classified event. The machine learning system having been generated by processing data from the one or more data feeds and data from the response plan database and the event plan database.

In some aspects, the system includes a database of a plurality of UAVs available for launch from a law enforcement vehicle and/or from one or more fixed city locations in a surrounding area of the surveilled area, and the event database and a flight plan database each store information pertaining to each UAV available for launch.

In some aspects, the controller is configured to receive information pertaining to one or more conditions determining readiness of one or more UAVs of the plurality of UAVs for launch.

In some aspects, the controller, based on the match, is configured to launch a first UAV of the plurality of UAVs to identify an intruder associated with the event, cause a second UAV of the plurality of UAVs to alert one or more persons in a vicinity regarding the event, cause a third UAV to track and identify a location of a law enforcement officer in the vicinity, travel to the law enforcement officer, and/or guide the law enforcement officer to the event and/or the intruder.

In some aspects, the one or more conditions include one or more of available UAV flight times, a charge state of a power source, and/or a UAV tolerance to one or more meteorological conditions.

In some aspects, the controller is configured to select a flight plan from the flight plan database based on the information pertaining to the one or more meteorological conditions, and output the selected flight plan to the one or more UAVs of the plurality of UAVs with determined readiness based on greatest amount of matching of the one or more conditions.

In some aspects, the selected flight plan includes a three-dimensional space defined by lateral and longitudinal distance ranges for one or more altitude ranges.

In some aspects, the controller is configured to receive data from one or more sensors installed on one or more UAVs and/or the surveilled area, including one or more event location data, determine a direction of movement of a suspected intruder based on the received one or more event location data and sensed characteristics of the suspected intruder, determine, from the response plan database, one or more UAV response and flight patterns, according to criteria threat assessment of the suspected intruder, and/or output the selected response plan to a UAV flight control system operable to allow multiple UAVs to navigate to one or more locations of the surveilled area.

In some aspects, the one or more criteria comprises a UAV attendance profile comprising one or more confrontation actions, one or more observation actions, and/or one or more aiding another UAV actions.

In some aspects, the one or more confrontation actions include an action plan directing one or more UAVs to the alert location in collaboration with an onboard UAV controller to oppose the determined direction of movement of the suspected intruder.

In some aspects, the UAV attendance profile includes a flight plan directing one or more UAVs to a location of the surveilled area associated with the one or more alerts to follow a determined direction of movement of the suspected intruder, and the flight plan output to the one or more UAVs includes instructions to deliver, when at or approximate to the location, one or more on-board effects comprising emissions of soundwaves, frequencies in the electro-magnetic spectrum, and reception and onward transmission of data related to the one or more on-board effects.

In some aspects, the controller is configured to receive event related data from one or more sensors installed on one or more UAVs and/or the surveilled area; and transmitting the event related data to one or more non-law tamper-resistant secure enforcement servers.

In some aspects, a method is disclosed for operating a response system one or more unmanned aerial vehicles (UAVs). The method includes receiving event type data and event location data from data feeds associated with sensors of a surveilled area, classifying an event of the surveilled area by determining a match between a total score of the event compared with event data of the one or more data feeds and one or more event types in the event database, determining, based on the match, one or more UAV response operations from a response plan database configured to store and predict one or more predetermined response actions, and outputting the determined one or more UAV response operations to a UAV flight control system so as to cause one or more UAVs to implement the one or more UAV response operations.

In some aspects, the step of receiving event type data and event location data from data feeds includes receiving data from one or more sensors installed on the one or more UAVs and/or the surveilled area, data from the one or more sensors comprising a data feed of defined by data from one or more social media networks of user devices within a geofence associated with the event dynamically determined based on users with location-aware devices entering or exiting the geofence.

In some aspects, a threat response system and method for a vehicle is disclosed. The system includes a response and alert generator configured to determine, based on one or more data feeds including event type data and event location data related to a surveilled area of a vehicle, a presence of one or more threats and output one or more alerts based on the determined presence of the one or more threats. The system also includes a response plan database configured to store and/or predict one or more predetermined action plans operable to direct one or more unmanned aerial vehicles (UAVs) to respond to the determined one or more threats directed at the vehicle. The system may also include an event database and a controller. The event database is configured to store a plurality of event types predetermined as suitable for a UAV response. The controller can receive data from the one or more data feeds associated with the surveilled area, the data including the event type data and the event location data, determine a match between event data of the one or more data feeds and one or more event types in the event database, determine, based on the match, one or more UAV threat response operations, and/or cause the one or more UAVs to perform the one or more UAV threat response operations.

In some aspects, the one or more UAV threat response operations include one or more UAVs launching from the vehicle to identify an intruder associated with the one or more threats, causing the one or more UAVs to follow and/or distract the intruder from trying to harm or break into the vehicle, alerting, by the one or more UAVs, one or more persons in a vicinity of the vehicle regarding the determined one or more threats, and tracking and/or identifying, by the one or more UAVs, a location of a police officer in the vicinity and/or guide the police officer to the vehicle and/or the intruder.

In some aspects, the vehicle is an automobile, a bus, a limousine, an aircraft, a boat, a helicopter, a tractor, a construction vehicle, or a motorcycle.

In some aspects, the vehicle is a state vehicle (e.g., a city vehicle, a police vehicle, a first responder vehicle, an ambulance, a fire engine, a highway patrol office vehicle, etc.).

In some aspects, the controller is configured to share the data with a local network based on a determined geolocation data calculated from the event location data, and use the local network as an information relay mesh that enhances communication of the one or more UAVs with a command center.

In some aspects, the controller is configured to receive data from one or more sensors installed on the one or more UAVs and/or the surveilled area.

In some aspects, data from the one or more sensors include a video data feed.

In some aspects, data from the one or more sensors include an audio data feed.

In some aspects, data from the one or more sensors include an UAV location feed and a telemetry feed.

In some aspects, data from the one or more sensors include a status feed of nearby crowd-sourced mesh.

In some aspects, data from the one or more sensors include a facial recognition data feed for law enforcement use.

In some aspects, the controller is configured to analyze event data of the one or more data feeds to determine the match by applying a machine learning system to identify one or more salient characteristics to event types and apply a score based on the identified event type. The machine learning system having been generated by processing data from the one or more data feeds and data from the response plan database and the event plan database.

In some aspects, a database of a plurality of UAVs available for launch from the vehicle and/or in a surrounding area of the surveilled area, and the event database and a flight plan database each store information pertaining to each UAV available for launch.

In some aspects, the controller is configured to receive information pertaining to one or more conditions determining readiness of one or more UAVs of the plurality of UAVs for launch.

In some aspects, the controller, based on the match, is configured to launch a first UAV of the plurality of UAVs to identify an intruder associated with the one or more threats, cause a second UAV of the plurality of UAVs to alert one or more persons in a vicinity regarding the one or more threats, cause a third UAV to track and identify a location of a police officer in the vicinity, travel to the police officer, and/or guide the police officer to the vehicle and/or the intruder.

In some aspects, the one or more conditions include one or more of available UAV flight times, a charge state of a power source, and/or a UAV tolerance to one or more meteorological conditions.

In some aspects, the controller is configured to select a flight plan from the flight plan database based on the information pertaining to the one or more conditions; and output the selected flight plan to the one or more UAVs of the plurality of UAVs with determined readiness based on a greatest amount of matching of the one or more conditions.

In some aspects, the selected flight plan includes a three-dimensional space defined by lateral and longitudinal distance ranges for one or more altitude ranges.

In some aspects, the system including a UAV control base positioned in the surveilled area configured as a local control station for the one or more UAVs. The local control station is configured to control navigation of the one or more UAVs and communicate with the controller and one or more of a plurality of UAVs in a three-dimensional space.

In some aspects, the controller is configured to receive, from the UAV base and/or the one or more UAVs, video and/or audio data feeds by way of a cloud-based controller server and/or remote computing device-based controller server.

In some aspects, the controller is configured receive one or more event location data, determine a direction of movement of a suspected intruder based on the received one or more event location data; determine, from the response plan database, one or more UAV response and flight patterns, according to one or more criteria. The controller may also be configured to output the selected response plan to a UAV flight control system operable to allow multiple UAVs to navigate to an alert location of the surveilled area.

In some aspects, the one or more criteria includes a UAV attendance profile including one or more confrontation actions, one or more observation actions, and/or one or more aiding another UAV actions.

In some aspects, the one or more confrontation actions include an action plan directing the one or more UAVs to the alert location in collaboration with an onboard UAV controller to oppose the determined direction of movement of the suspected intruder.

In some aspects, the UAV attendance profile includes a flight plan directing the one or more UAVs to a location of the surveilled area associated with the one or more alerts to follow a determined direction of movement of the suspected intruder.

In some aspects, the flight plan output to the one or more UAVs further includes instructions to deliver, when at or approximate to the location, one or more on-board effects including emissions of soundwaves, frequencies in the electro-magnetic spectrum, and reception and onward transmission of data related to the one or more on-board effects.

In some aspects, the flight plan output to the one or more UAVs further includes instructions to retrieve from a police car and to deliver, when at or approximate to the location of the police officers, one or more firearms and/or weapons to the police officers.

In some aspects, the UAV attendance profile includes a collaborative flight plan directing the one or more UAVs to a location of the surveilled area associated with the one or more alerts in either aiding the other UAV or to replace a malfunctioning UAV and connect to a controller of the UAV base.

In some aspects, a method of operating a response system having one or more UAVs is disclosed. The method can include receiving event type data and event location data from data feeds associated with sensors of a surveilled area associated with a vehicle, determining a match between the event type and one or more event types in an event database, the event database being configured to store a plurality of event types including one or more UAV event type responses, determining, based on the match indicating one or more threats at the surveilled area, one or more UAV threat response operations from a response plan database configured to store and predict one or more predetermined response actions, and/or outputting the determined one or more UAV threat response operations to a UAV flight control system so as to cause one or more UAVs to implement the one or more UAV threat response operations. In some aspects, the one or more UAV threat response operations include launching one or more UAVs from the vehicle to identify an intruder associated with the one or more threats, causing the one or more UAVs to follow and/or distract the intruder from trying to harm or break into the vehicle, alerting, by the one or more UAVs, one or more persons in a vicinity of the vehicle regarding the determined one or more threats, and/or tracking and/or identifying, by the one or more UAVs, a location of a police officer in the vicinity and/or guide the police officer to the vehicle and/or the intruder.

In some aspects, a non-transitory computer-readable medium storing instructions that, when executed by a processor to perform a method. The method can include receiving event type data and event location data from data feeds associated with sensors of a surveilled area associated with a vehicle, determining a match between the event type and one or more event types in an event database, the event database being configured to store a plurality of event types including one or more UAV event type responses, determining, based on the match indicating one or more threats at the surveilled area, one or more UAV threat response operations from a response plan database configured to store and predict one or more predetermined response actions, and/or outputting the determined one or more UAV threat response operations to a UAV flight control system so as to cause the one or more UAVs to implement a flight plan associated with the one or more UAV threat response operations.

In some aspects, the method of the instructions further includes receiving, from a UAV base of the event location and/or the one or more UAVs, video and/or audio data feeds of the data feeds by way of a cloud-based controller server and/or remote computing device-based controller server.

In some aspects, a controller system is disclosed for controlling an unmanned aerial vehicle (UAV), the controller system including at least one memory storing instructions, and at least one processor configured to execute the instructions to perform operations. The operations can include any herein disclosed method.

Other aspects and features of the present disclosure will become apparent to those of ordinary skill in the art, upon reviewing the following detailed description in conjunction with the accompanying figures.

### BRIEF DESCRIPTION OF THE FIGURES

The above and further aspects of this disclosure are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation.

FIG. 1 is a flowchart illustrating an exemplary method for operating a response system for one or more UAVs where an event at a surveilled area is detected, according to an example embodiment.

FIG. 2A is an illustration of one or more UAVs of an event response system in use in an event between law enforcement and a citizen, according to an example embodiment.

FIG. 2B is a block diagram of an exemplary UAV for use in the system of FIG. 2A in communication with one or more local and/or cloud-based databases, according to an example embodiment.

FIG. 2C is an illustration of one or more UAVs of an event response system where the UAVs are positioned in one or more locations of a city for use in responding to an event, according to an example embodiment.

FIG. 3 is a block diagram of a computing system in communication with exemplary aspects of the disclosure, according to an example embodiment.

FIG. 4 is a block diagram of an exemplary UAV computing system in communication with an example control base and the example cloud-based computing system of FIG. 3, according to an example embodiment.

FIG. 5 is an illustration of a UAV being alerted to a suspected intruder of a surveilled vehicle, according to an example embodiment.

FIG. 6 is a flowchart illustrating an exemplary method for operating a response system for one or more UAVs where a threat at a surveilled area is detected, according to an example embodiment.

FIG. 7 is a flowchart illustrating an exemplary method for operating a controller of a response system for one or more UAVs, according to an example embodiment.

FIG. 8 is a computer architecture diagram showing a general computing system for implementing aspects of the present disclosure, according to an example embodiment.

### DETAILED DESCRIPTION

Throughout this disclosure, certain embodiments are described by way of example in relation to designing, operating, and maintaining a security system including one or more unmanned aerial vehicles (UAVs) for monitoring, identifying and/or responding to a threat at a surveilled area (e.g., a suspected intruder trying to harm or break into a protected vehicle). Some embodiments of the present disclosure will be described more fully hereinafter with reference to the accompanying drawings. This present disclosure may, however, be embodied in many different forms and should not be construed as limited to the embodiments set forth herein.

As used herein, the term “unmanned aerial vehicle” (UAV) may be used interchangeably with a drone or “radio-controlled” (RC) aircraft where appropriate.

In some instances, a computing device may be referred to as a mobile device, mobile computing device, a mobile station (MS), terminal, cellular phone, cellular handset, personal digital assistant (PDA), smartphone, wireless phone, organizer, handheld computer, desktop computer, laptop computer, tablet computer, tablet, terminal, display device, or some other like terminology. In other instances, a computing device may be a processor, an electronic control unit (ECU), a controller, a server, or a central processing unit (CPU). In yet other instances, a computing device may be a set of hardware and software components.

In some aspects, this disclosure relates to a system configured to enhance safety of citizens and state officials (e.g., law enforcement officers as well as other first responders). In operation, the system can be configured to enhance safety of citizens who encounter state officials, such as law enforcement personnel. The system can include one or more UAVs that relay information to each other, a central command center, and/or a social media network in a transparent and unbiased format. Each UAV can be equipped with sensors and firmware to assist in relaying salient information of an event to appropriate personnel (e.g., a law enforcement officer who is closest to a site of interest) to assist situation and safety level assessment (e.g., the type of situation and related safety of an encounter between a citizen and police) as well as notify other citizens and law enforcement officials regarding the event (e.g., via a remote command center, notifications in one or more social media networks, emergency push notifications to devices within a geofence of an area, an alarm and/or LED light patterns, etc.).

In some aspects, the system of this disclosure is also configured to provide a tamper-proof database to related to the event. For example, a first portion of the event (e.g., the first ten minutes of an event) captured by system of this disclosure related to an interaction between a citizen and law enforcement personnel can include audio and/or video data stored in a server of a first remote command center (e.g., a center of a command center database) while a second portion of the event (e.g., the second ten minutes of the event) can be stored in a server of a second remote command center. The servers of the remote command centers can be replicated in a central database as well as multiple locations and/or can store different data types, different data sets, and/or the same data in multiple locations so to improve data availability and accessibility, and to improve system resilience and reliability. In turn, the presence of this database enhances the safety of law enforcement personnel and citizens alike. For law enforcement personal, confrontation between law enforcement and citizens is one of their riskier tasks. The system can process data before a potentially confrontational event as well as interface between officers and citizens.

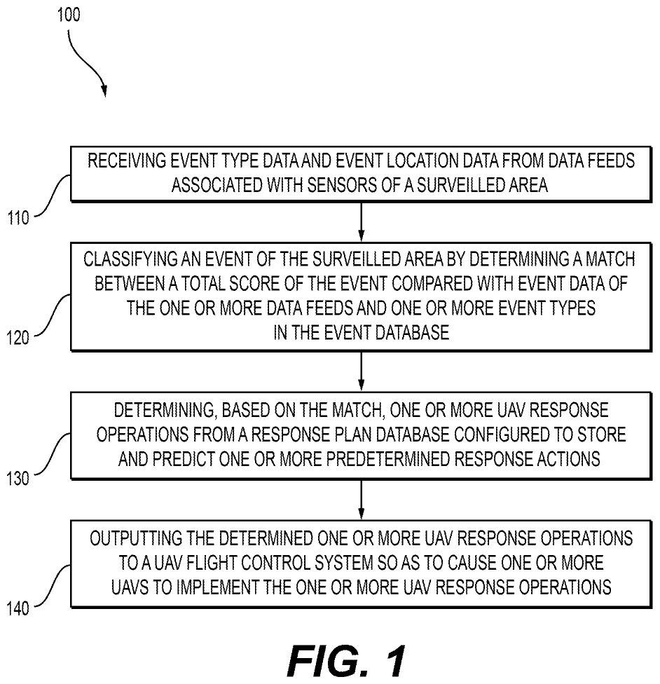

Referring to FIG. 1, a flow diagram of an example method 100 of operating a response system including one or more UAVs is illustrated. According to one embodiment, the exemplary method 100 may be implemented by a controller system having memory storing instructions and a processor to execute these instructions to perform operations of method 100 including one or more of the steps of method 100. The method 100 (e.g., steps 110 to 140) may be performed automatically in response to the detected event and/or in response to a request (e.g., from a user). In some aspects, the one or more UAVs of the system can be attached to or otherwise installed with a vehicle (e.g., a state vehicle such as a law enforcement vehicle, an ambulance, a fire response vehicle, a coast guard vehicle, etc.), whereby the one or more UAVs can include sensors used to detect aspects of an event. In some aspects, such sensors can also be used to predict the threat (e.g., based on historical data prior to it happening). The sensors are able to identify objects, persons, vehicles, firearms, weapons, etc.

In step 110, the method may include receiving event type data and event location data from data feeds associated with sensors of a surveilled area. In step 120, the method may include classifying an event of the surveilled area by determining a match between a total score of the event compared with event data of the one or more data feeds and one or more event types in the event database. For example, as soon as an event is detected, one or more UAVs can be immediately launched. In step 130, the method may include determining, based on the match, one or more UAV response operations from a response plan database configured to store and predict one or more predetermined response actions. In step 140, the method may include outputting the determined one or more UAV response operations to a UAV flight control system so as to cause one or more UAVs to implement the one or more UAV response operations. One event type response can include one or more UAVs can be launched from the vehicle and/or nearby base in response to detecting the threat. In some aspects, a detected threat event response can include one or more UAVs 270 launching (e.g., from a roof and/or a trunk of the vehicle. Other event type response operations can include launching a first UAV to identify a suspect associated with the event (e.g., through facial recognition) and follow, track, and/or distract the suspect from further conduct, such as continuing a particular crime associated with the event or evading capture. Another UAV response operation includes launching a UAV to similarly alert people in the vicinity of the event (e.g., a neighbor, a bystander, a responding law enforcement officer, etc.) that an event related is happening and to stay away or seek help. Another UAV threat response operation includes launching a third UAV to track and identify the location of a police officer in the vicinity, travel to the police officer, and/or guide the police officer to the vehicle and/or the intruder. All UAVs of the response system can be in communication with each other as well as a central controller to facilitate harm prevention between a responding law enforcement officer and a citizen associated with the event. As used herein, the term “in communication” means direct and/or indirect communication through one or more intermediary components and does not require direct physical (e.g., wired and/or wireless) communication, including selective communication and/or one-time events.

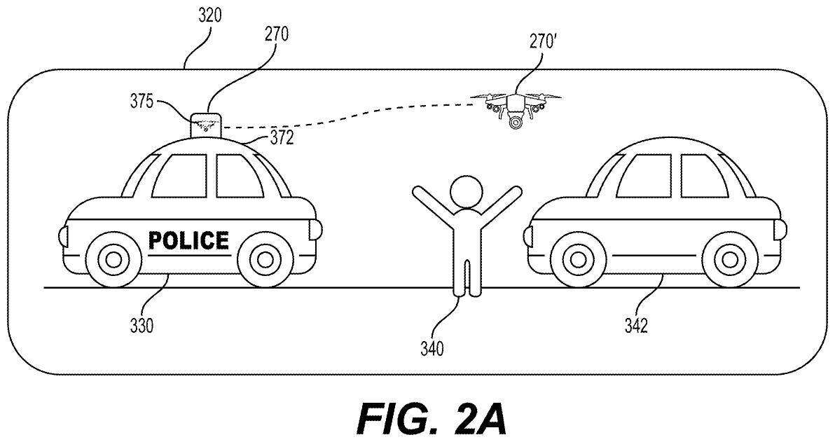

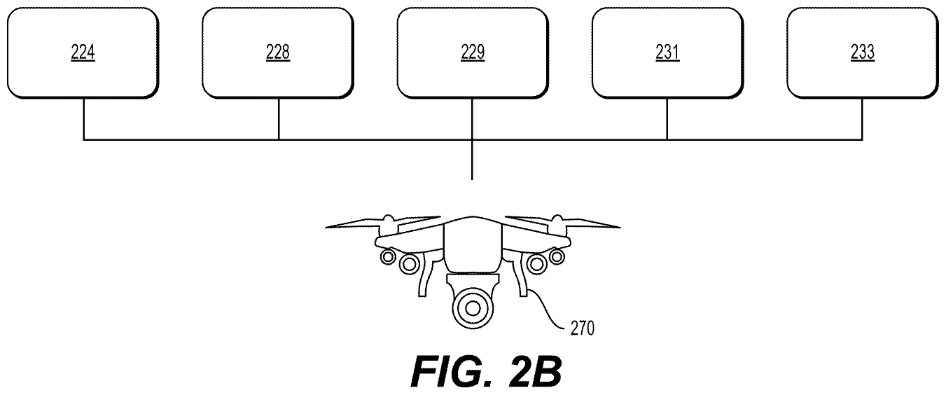

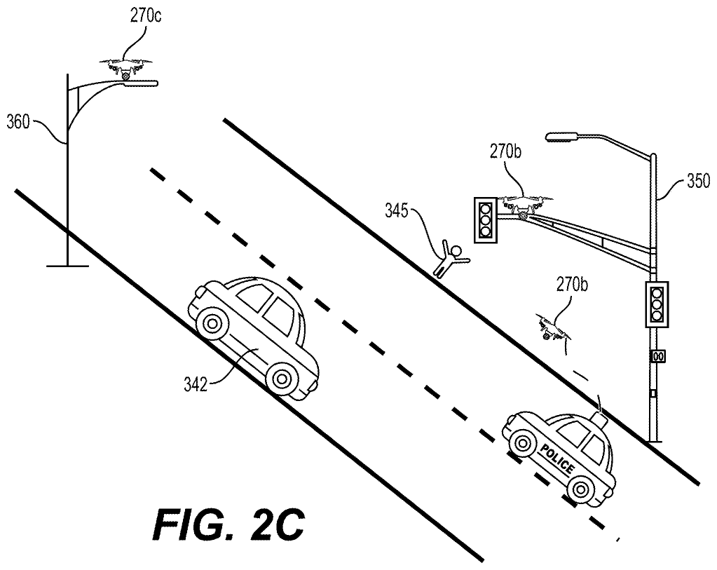

Turning to FIG. 2A, an exemplary schematic is shown with one or more UAVs 270 installed with a law enforcement vehicle 330. The one or more UAVs 270 can be launched on demand or automatically in response to instructions from a control center (e.g., in response to determining that an event of interest 320 is occurring such as one between law enforcement 330 and a citizen 340). One or more UAVs 270 being launched from the vehicle 330 can serve as a safety guard for law enforcement officers associated by being present and witnessing event 320 and by relaying real-time information related to event 320 (e.g., to one or more command centers), to one or more users of a social media network (e.g., those users of within the geofence associated with event 320), and/or any server locally or remotely connected thereto. This advantageously provides a system external to and independent of law enforcement's control center; instead, the system creates and maintains one or more event data feeds that can be transmitted to non-law enforcement servers and/or control centers. In some aspects, such non-law enforcement servers may be incapable of or prevented to share data with law enforcement until authorization is granted by a non-law enforcement entity which ensures that the data is not tampered with or improperly accessed. In some aspects, data tampering can be performed by using one or more of blockchain, authentication tokens, digital signatures, tamper resistant protocols, firewalls, and/or the like. Also, by using access controls to protect data in persistent stores to ensure that only authorized users can access and modify the data, and by using role-based security to define which users can view data and which users can modify data.

In one example, when the officer of vehicle 330 pulls over citizen 340 in FIG. 2A, UAV 270 can send a blast alert to citizens in the surrounding area of event 320 (e.g., citizen 340) determined to be in the danger or incident area (e.g., within approximately 1 to 2 mile radius). In some aspects, a corresponding graphical user interface embodying aspects of the response system can be presented in an app on a user device that allows citizens to view and/or listen in real-time to things being seen by UAV 270. Users using the app can view can be alerted when events of interest occur (e.g., that a law enforcement officer has pulled over someone). The alert can include the exact location of the law enforcement officer and any other information to identify aspects or otherwise classify the event 320. The app advantageously provides a level of accountability since users are able to watch and listen to conduct of the law enforcement officer. In observing event 320, interested users are able to travel to event 320 to make sure everything is okay as between the officer and citizen 340.

FIG. 2B depicts an illustration of a block diagram of a response system with exemplary UAV 270 in communication with a plurality of databases, including but not limited to an intelligent recharging database 224, an audiovisual database 228, an autonomous response generator 312 (as discussed below), a networked crowdsource database 231, and a command center database 233. In turn, UAV 270 receives various types of data, information, commands, signals, and the like, from the sensors (e.g., sensors associated with smart city components, vehicles, and other data sources) and subsystems described herein.

The database 224 can include a database of charging locations (e.g., locations within a city such as a docking station or charging receiver positioned in a location such as a street light, a stop sign, a public park, a school, a stadium, etc.) and intelligent charging logic including range, assigned flight operations, and available charge. For example, the database 224 can include logic for determining the estimated consumption for a flight operation of UAV 270, logic for setting a target end point for the energy storage system based upon charge levels of an onboard battery of UAV 270, and logic for determining available charging locations for UAV 270 based upon available response operations and the determined estimated consumption.

The database 228 can include data feed associated with onboard sensors 262 of UAV 270 as well as data from other audiovisual databases (e.g., audiovisual data feeds from other UAVs 270 as well as data feeds from other users, citizens, law enforcement, and audiovisual “smart city” components, such as remotely connected traffic cameras).

The database 231 can include a database defined by data from one or more social media networks of user devices 235 within a geofence associated with event 320 can be dynamically determined based on users with location-aware devices 235 entering or exiting the geofence. Examples of social media networks for use with database 231 can include Facebook™, Twitter™, Instagram™, TikTok™, LinkedIn™, Pinterest™ Youtube™, SnapChat™, Reddit™, and other present and future social media network systems. Advantageously, the database 231 can be redundant with no single point of failure thereby providing for distributed accountability for individuals involved in event 320 (e.g., the citizen and/or the law enforcement officer).

The database 233 can be a database in communication with one or more command centers for controlling operations of UAV 270. As used herein, the term “in communication” means direct and/or indirect communication through one or more intermediary components and does not require direct physical (e.g., wired and/or wireless) communication, including selective communication and/or one-time events. Command centers associated with the database 233 can be configured to control launch and other flight operations of corresponding UAVs 270.

Once launched from vehicle 330, the one or more UAVs 270 can be used to acquire information about one or more citizens identified related to the event of interest, communicate with the respective citizen (e.g., via push notification to an associated mobile device, by emitting an alert sound and/or LED pattern to the respective citizen and/or law enforcement personnel on scene from the UAV 270), and similarly communicate with other members of a crowd-sourced social media network (e.g., the database 231) within a geofence associated with event 320t. As used herein, the term “geofence” means a virtual perimeter of the geographic area associated with the event of interest and can be dynamically generated or match a predefined set of boundaries.

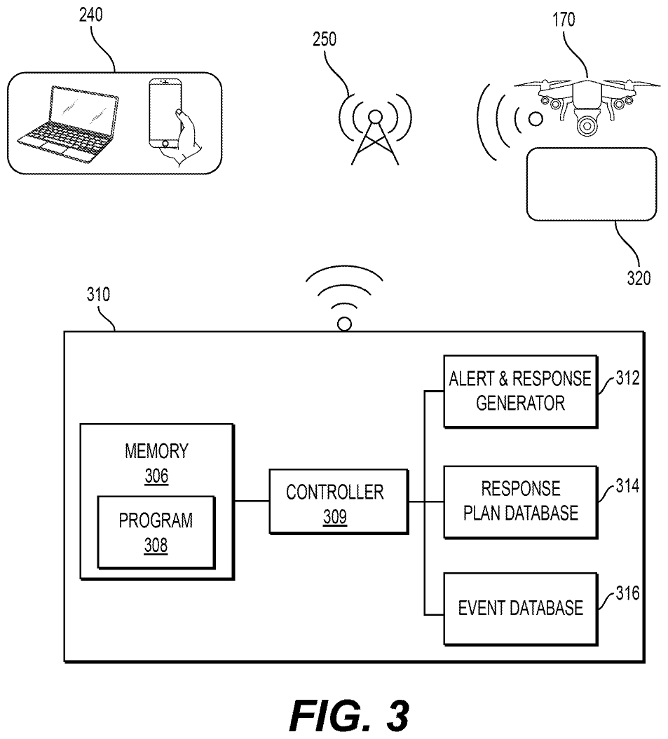

The one or more UAVs 270 can be docked in a docking station 375 on the roof 372 of the vehicle 330 and can autonomously and/or manually be launched therefrom to perform a flight operation (e.g., UAV 270′ which has been launched from vehicle 330) around a stopped citizen vehicle 342 or a citizen 340 without any assistance from the officer of vehicle 330. The launched UAV 270′ can perform key tasks autonomously, such as determining objects or events of significance, flying to the determined objects or events of significance and recording information with onboard sensors 262 of UAV 270′ related to event 320 (e.g., audiovisual data, information related to vehicle 342, information related to citizen 340, etc.). Sensors 262 can include sensors including cameras as well as those configured to measure ambient temperature, cabin temperature, moisture, interior cabin pressure of a vehicle, accelerometers to detect acceleration, telemetry data, location data, etc. Sensors 262 can also include an inertial measurement unit (IMU) having one or more of an accelerometer, a gyroscope, and a magnetometer which may be used to estimate acceleration and speed of UAV 270. Sensors 262 can also include infrared sensors, thermal sensors, LIDAR sensors, GPS sensors, magnetic sensors, current sensors, and the like. Sensors 262 can include wireless transceivers so as to transmit sensor data (e.g. temperature data feeds, moisture data feeds, pressure feeds, accelerometer feeds, telemetry data feed, location data feeds, etc.). In some aspects, sensors 262 can be used to anticipate a pending threat based on historical data prior to it happening, as discussed more particularly below in FIG. 3. Based on information from the one or more sensors 262, as soon as an initial threat is detected one or more UAVs 270 can be immediately launched. Sensors 262 of UAV 270 can also include one or more cameras with night vision, infrared cameras, microphones, and the like, so as to allow UAV 270 to capture video and provide a live feed and perform threat assessment logic at night or in low light conditions.

In some aspects, the one or more UAVs 270 can be trained to use onboard sensors 262 (e.g., onboard camera) to capture license plate information related to vehicle 342 as well as capture facial recognition data associated with any related citizens 340, potential hazards and navigating through or around obstacles of event 320 (e.g., trees, other oncoming objects such as vehicles or approaching citizens, spaces such as allies between structures, etc.). For example, UAV 270 can be configured to launch from vehicle 330 and arrive near vehicle 342, hover thereabout at roughly the same altitude as a law enforcement officer's head, and scan interiors of vehicle 342 (e.g., through the vehicle windows). UAV 270 can also scan interiors of vehicle 342 and analyze aspects of the dashboard for any weapons, illegal substances, and/or products that could harm or injure the officer as well as citizen 340.

In some aspects, a computer of vehicle 330 is in communication with UAV 270′ while in flight and can receive real-time data. When the UAV 270 launches from vehicle 330, the event 320 is classified and based on a total score and match between event 320 and corresponding response operation, an optimum flight path is determined. UAV 270 is launched as an in-flight UAV 270′ flying towards citizen 340 and/or vehicle 342 while avoiding traffic and other obstructions. During operation, UAV 270′ is configured to relay sensed information related to event 320 to the officer of vehicle 330 even before the officer needs to vacate vehicle 330 and potentially confront citizen 340. By providing event-related information prior to the officer having to personally interact with citizen 340 and thus minimizing unnecessary bias by either party, the likelihood of danger between the officer and individual is reduced. In some aspects, upon arriving at vehicle 342, UAV 270′ can emit sounds (e.g., emitting audio declaring that the UAV 270′ is there as a protector of citizen 340) and/or other citizen perceptible output (e.g., blinking lights of one or more colors, etc.). The UAV 270′ can notify those related to event 320 regarding aspects related to its flight operations, including that it is presently or will initiate recording event 320 and will notify other citizens within the geofence of event 320. The UAV 270′ may further announce that it will relay information sensed by sensors 262 to one or more remote servers and/or remote command centers.

In some aspects, sensors 262 of UAV 270′ can be configured to receive instructional input from citizen 340. For example, citizen 340 can call out to UAV 270′ that further help is necessary or to initiate audio-visual recording and/or transmission to external servers. In some aspects, citizen 340 can also have one or more system actuators configured to transmit a distress signal so as to notify additional authorities, the nearby UAVs, and other citizens with the mobile device application of the dangerous situation. Upon receiving the distress signal, one or more UAVs are dispatched to the device of citizen 340 or any other device (e.g., any other remotely connected user device 240) that sent the SOS signal.

In one embodiment, UAV 270′ of FIG. 2A is aware of a location of a law enforcement officer (e.g., the law enforcement officer associated with vehicle 330) by an RF ID tag or other device attached to the officer. In one example operation, UAV 270′ travels ahead of vehicle 330 and/or the related officer and uses sensors 262 to assess the area surrounding vehicle 330 for obstacles or other potentially dangerous activities or situations (e.g., suspects, active shooters, guns, bombs, explosives, dangerous objects, etc.). UAV 270′ can scan the ground as well as any nearby structures (e.g., buildings and balconies up above) for threats. In some aspects, UAV 270 can launch from vehicle 330 and travel approximately several city blocks ahead of vehicle 300 (e.g., approximately 400 m to 500 m) to perform threat assessment logic, secure the premises, and/or notify the officer of any potential dangers related to event 320 associated by performing event assessment logic and/or threat assessment logic. Example threat assessment logic can include analyzing data from onboard sensors 262 as well as any remotely connected devices (e.g., “smart” city components), classifying the analyzed data according to an event type, determining an event assessment based on the classified event type. The term “smart” as used herein is intended to mean mounted sensors and/or detectors that collect and/or generate data and/or other data detailing or associated with aspects such as movement and behavior of people, vehicles, and the like. Such smart devices can be configured to broadcast the sensed data to one or more other devices, such as to vehicles within an area, other infrastructure components, remote servers, or other computing device devices of state authorities (e.g., law enforcement, fire response, ambulance drivers, dispatchers, other city personnel), drivers, pedestrians, cyclists, and/or the like. In operation, if the determined event assessment exceeds a predetermined threat threshold according to the event type, the UAV 270 can carry out one or more threat response operations.

Threat response operations can include causing one or more alerts to be transmitted to computing devices within a geofence of the ongoing event 320 as well as system users, responding officers, and other first responders, with a threat description (e.g., the type of threat, the location, timing information, as well as providing access to real-time data associated with event). Threat response operations can also include transmitting data mined by UAV 270 to the officer and alert the officer regarding the threat assessment. Threat response operations can also include causing, based on the threat assessment, UAV 270 to follow one or more suspects identified with the ongoing event 320. Where UAV 270 assesses that multiple suspects are present, UAV 270 can further assess which of the suspects presents the greatest threat (e.g., the suspect with a firearm or having the most ammunition, etc.) and based on the suspect threat assessment, following the suspect determined to present the greatest threat. In those instances where multiple suspects are assessed, UAV 270 can coordinate with one or more additional UAVs 270 (e.g., via database 233) so that other suspects headed in a different direction can be tracked to the extent possible.

As shown in FIG. 2C, UAVs 270a, 270b, 270c can also be located or positioned with or near city infrastructure. For example, UAV 270a can be positioned with vehicle 330 while UAV 270b can be nested and/or docked with traffic lights 350 and UAV 270C can be nested and/or docked with street lights 360. While not shown, other UAVs 270 can be positioned with stop signs, city parks, public schools, airports, bridges, power lines, factories, power plants, shipping facilities, stadiums, public venues, etc. City infrastructure near or positioned with UAVs 270 can also charge UAV internal power supplies (e.g., onboard direct current batteries). In operation, UAV 270b from a first piece of infrastructure (e.g., light 350) can coordinate with UAV 270c from a second piece of infrastructure (e.g., light 360) to assist if the circumstances dictate, to launch if one UAV is running low on charge or requires assistance, etc. Multiple other UAVs can be dispatched to assist the UAVs that are in flight.

In some aspects, UAVs 270a, 270b, 270c of FIG. 2C can also be in communication with infrastructure computing devices such as one or more of a city's remote servers and other smart infrastructure components such as smart traffic signals, smart traffic lights, smart toll booths, smart school signals, smart city signals, embedded sensors within roadways or bridges, and/or additional sensors in vehicles. In some aspects, a first UAV 270a can be launched from vehicle 342 (while vehicle 342 is moving or parked) in a response flight operation to identify an event of interest. For example, UAV 270a can be launched towards a citizen 345 and/or vehicle 342 to further identify either (e.g., through facial recognition, license plate recognition, graphic comparison to identify make/model of vehicle 342, etc.) and to follow, track, and/or distract citizen 345 and/or vehicle 342 from further action (e.g., by emitting distracting audio such as a siren or a message announcing that peace officers have been notified, by flashing one or more LEDs, etc.). A second UAV 270b can be simultaneously launched from light 350 in another response operation to similarly alert people in the vicinity [e.g., a neighbor, a bystander, a police officer, etc.], emitting distracting audio such as a siren or a message announcing that law enforcement officers have been notified, by flashing one or more LEDs, etc.), that a crime or some harmful event is happening and to stay away or seek help. A third UAV 270c be simultaneously launched from light 360 in another response operation to track and identify the location of a police officer in the vicinity, travel to the police officer, and/or guide the police officer to the event of interest and/or a suspected intruder. In some aspects, all UAVs 270a, 270b, 270c can be in communications with one another to help assist in preventing the harm from happening to people and property and to direct officials as needed.

In some aspects, the sounds and/or lights emitted, if any, from UAVs of this system can depend on the respective state vehicle it is supporting. For example, UAVs used in law enforcement applications can include sirens as well as emit light patterns similar to a typical law enforcement vehicle. While aspects of the system shown in FIGS. 2A to 2C have been discussed using the example of a law enforcement officer, the solution of this disclosure is not so limited. In some aspects, the system can be implemented with other state vehicles such as ambulances, fire response vehicles, coast guard vehicles, and the like. While the surveillance target vehicle 260 is shown as an automobile, other vehicles can be used for use with the herein disclosed solution. Other example vehicles can also include armored vehicles for banks, commercial vehicles (e.g., e.g., bus, limousine, etc.), an aircraft (e.g., a personal aircraft such as those made by the Cessna Aircraft Company, a commercial aircraft, a boat, a helicopter, farm-related vehicles (e.g., tractor, cargo all-terrain vehicles), construction vehicles (e.g., dump truck, excavator, digger, etc.), motorcycles, as well as any other vehicle generally known in the art. In each specific example, corresponding UAVs can be color coded for the associated use. For example, UAVs used with law enforcement can be blue, UAVs used with ambulances can be red-yellow, UAVs used with fire response can be red, and UAVs used with coast guard can be red-yellow and blue on top. The provided color schemes are merely exemplary and any number of color combinations can be used depending on the application with respective state vehicles.

In those examples where the response system is used with an ambulance, UAV 270 can include a navigation system with an ambulance location module configured to track the ambulance destination. Based on this information, UAV 270 can launch and travel ahead of the ambulance to clear the roads of other vehicles so the ambulance can travel to the emergency location more safely and faster. Similar to other examples of this disclosure, UAV 270 can be configured to emit an alert sound (e.g., siren that matches a siren of the ambulance) and/or LED pattern (e.g., the flashing pattern that matches an ambulance) and can travel at a high speed to travel to intersections and stop signs so drivers can see UAV 270 and be alerted of the approaching ambulance. In some aspects, UAV 270 can include at least four sides with LED lights on all sides. In this example, UAV 270 can function as a multi-sided traffic light where each side is configured to cycle through green, yellow, and red depending on the traffic flow and direction and/or destination of ambulance.

In those examples where the response system is used with a fire response vehicle (e.g., a fire engine), UAV 270 can include flame resistant materials (e.g., flame resistant plastics) around the UAV housing as well as flight surfaces such as the propeller blades. In this example, UAV 270 can also include a fire extinguisher and other system for removing oxygen from the air so as to quickly put out a burning fire. UAV 270 can also be equipped with onboard infrared sensors and animal detection logic so as to detect presence of humans and/or pets within a burning structure. Upon detecting presence of humans and/or pets within the burning structure, UAV 270 can alert fire response officers as to specific location of the detected victims, number of victims, and other aspects thereof so that responding officers can be equipped to provide all necessary aid.

In those examples where the response system is used with coast guard vehicles, UAV 270 can be configured with obstacle assessment logic that can identify and locate obstacles such as sharks, whales, alligators, crocodiles, etc. Once located, UAV 270 can fly directly over the identified obstacle close to the water and sound an alarm and/or flashing lights to alert those about the identified obstacle. UAV 270 can also be configured to direct a beam of light toward the water to follow the identified obstacle. UAV 270 can continue tracking the identified obstacle so that people in the water can determine where the identified obstacle is going.

In some aspects, UAV 270 can also assist with rescues of people in the water at a beach, for example. UAV 270 can determine whether a person in the water is distressed (e.g., drowning or in need of help). Upon determining that a person in the water is distressed, a coast guard officer, a lifeguard, or any other rescue personnel can be immediately notified by UAV 270. Rescue personnel can communicate with UAV 270, including voice message(s) to UAV 270 which UAV 270 can broadcast to the distressed person. For example, the lifeguard on shore can use their user device (e.g., a mobile device with an associated app to communicate with UAV 270) and say, “Stay calm, help is on the way.” UAV 270 and one or more user devices 240 can utilize bi-directional communication protocols so that remote systems users, such as a lifeguard, can communicate with the identified distressed person.

In some aspects, UAV 270 can also provide aid to the distressed person by providing assistance if struggling to swim. For example, UAV 270 can release or drop an inflation device to the distressed person in the water. The inflation device can have a string or rope attached to UAV 270 and UAV 27 can pull the inflatable device and the person to the shore. In one embodiment, the inflation device can be advantageously formed in the shape of an egg or multiple eggs which are automatically inflated when travelling to the water by an inflation cartridge. The egg(s) is completely inflated before it hits the water. In some aspects, the egg(s) can be colored either a solid black or a solid blue because solid colors are not easily seen by sharks. A white or yellow stripe may also encircle the eggs to allow the distressed person to more easily see the egg(s). UAV 270 can include a storage compartment to store the inflation device. In some aspects, when UAV 270 detects that it is over a distressed person, a door on the storage compartment can automatically open and egg(s) then exit the storage compartment, automatically inflate, and then impact the water adjacent the distressed person. UAV 270 can also drop a water ski rope with a handle (e.g., stored in the storage compartment) for the distressed person. In some aspects, UAV 270 can travel back and forth so the water ski rope's handle is slightly above the water and can be positioned over the distressed person. The distressed person can then grab the handle and be pulled to safety by UAV 270.

Turning to FIG. 3, a block diagram of system 310 is shown in communication with network 250, UAV 270, and device 240. In particular, system 310 can be cloud-based and include memory 306 with one or more programs 308. System 310 can include a controller 309 in communication with an alert and response generator 312, response plan database 314, and an event database 316. The term “controller” as used herein encompasses those components utilized to carry-out or otherwise support the processing functionalities of system 310. In some aspects, controller 309 can encompass or may be associated with a programmable logic array, application specific integrated circuit or other similar firmware, as well as any number of individual processors, flight control computers, navigational equipment pieces, computer-readable memories, power supplies, storage devices, interface cards, and other standardized components. In some aspects, controller 309 can include one or more processors in communication with to data storage having stored therein operation instructions for various tasks.

System 310 can be cloud-based and/or be communicatively coupled directly to UAV 270 or indirectly via a network 250. The network 250 can be any combination of a local area network (LAN), an intranet, the Internet, or any other suitable communications network. One or more user devices 240 can also be in communication with system 310 via network 250. The user device 240 can be any suitable user computing device such as a mobile phone, a personal computer, a tablet, a wearable device, an augmented reality interface, or any other suitable user computing device capable of accessing and communicating using local and/or global networks. In some aspects, UAVs 270 may include one or more wireless network transceivers (e.g., a cellular modem, a Bluetooth transceiver, a Wi-Fi transceiver). In some aspects, one or more sensors 262 of UAV 270 as well as other sensors remotely connected thereto (e.g., smart city sensors, other vehicle sensors, etc.) detect activity and the UAV 270, in response to instructions including threat assessment logic from system 310, can perform one or more response operations (e.g., being launched, identifying and/or tracking aspects related to an event of interest, coordinating with other persons such as neighbors, owners, bystanders, police, distracting a suspected intruder, etc.) so as to initiate one or more response operations.

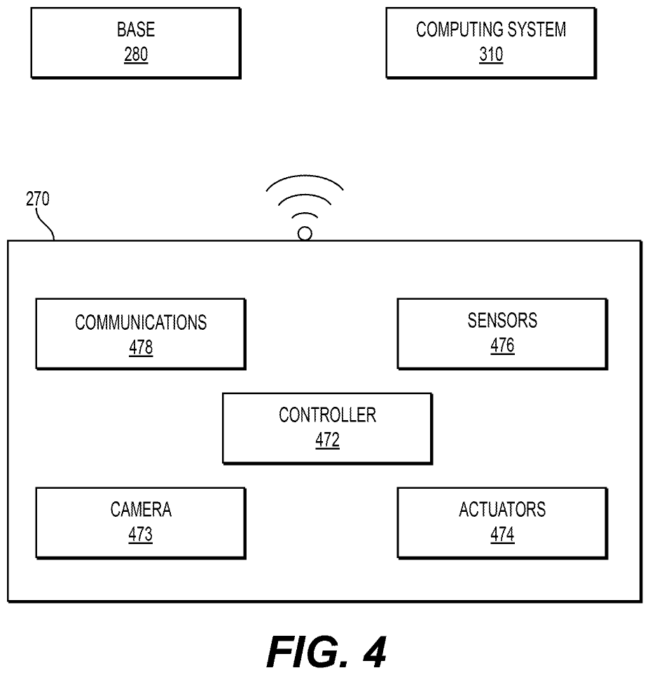

FIG. 4 is a block diagram of an exemplary UAV 270 in communication with base 280 and system 310. UAV 270 may be provided with various levels of control ranging from remote control (e.g., by one or more control centers of database 233, vehicle 330, a UAV base 280 and/or system 310) to autonomous control by onboard controller 472 based on a flight plan provided database 314 and based on sensed information related to event 320 and/or a related area of interest. Communication between UAV 270 and base 280 and/or system 310 may be through communication circuit 478 which has one or more onboard wireless transceivers. Onboard wireless transceivers of circuit 478 can include a radio for remote control (e.g., RF) as well as WiFi, Bluetooth, cellular (e.g., 3G, 4G, 5G, LTE, etc.) and global positioning system (GPS) interfaces. UAV 270 can include an onboard rechargeable power supply (e.g., a direct current battery such as a lithium-ion battery. As previously remarked, UAV 270 can also include one or more sensors 476 and one or more actuators 474. Sensors 476 can include an inertial measurement unit (IMU) having one or more of an accelerometer, a gyroscope, and a magnetometer which may be used to estimate acceleration and speed of UAV 270.

Sensors 476 can also include infrared sensors, thermal sensors, LIDAR sensors, GPS sensors, magnetic sensors, current sensors, and the like. Each of sensors 476 can each generate respective data feeds that, via circuit 478, can be transmitted with system 310 and/or base 280 to further evaluate to identify potential threats and determine related threat response actions by UAVs 270. Actuators 474 can include one or more rotor speed controls depending on how many rotors UAV 270 may have. In some aspects, UAV 270 is equipped with telepresence (e.g, with speaker, microphone, camera, etc.) and a plurality of sensors (e.g., sensors 262, 476) configured for obstacle-avoidance. As used herein, the term “telepresence” means a user, via sensors 476 of a respective UAV 270, remotely interacts with the geolocation associated with the event 320 as opposed to interacting virtually where a user is in a simulated environment. In some aspects, UAV 270 is able to map and identify objects of interest near or otherwise associated with event 320 along a flight operation route using onboard sensors 476 (e.g., one or more high-resolution digital cameras, laser (LiDAR) systems, and/or the like).

Turning back to FIG. 3, controller 309 can receive data from one or more data feeds associated with the surveilled area of event 320 (e.g., data feeds of sensors 476), the data including the event type data used to classify the event and event location data. Controller 309 can determine a match between event data of the one or more data feeds and one or more event types in the event database 316, and determine, based on the match, one or more UAV response operations from database 314. In some aspects, controller 309 can receive data from these one or more data feeds associated with event 320 as well as any surrounding area related to an ongoing event (e.g. smart city components, sensors of vehicles, data from other UAVs in use, etc.). In some aspects, controller 309 can share the data with network 250 based on determined geolocation data calculated from the event location data, and use network 250 as an information relay mesh to enhance communication of UAV 270 with one or more command centers (e.g., command centers of database 233). In this respect, network 250 can similarly be in communication with networked crowdsource database 231 so as to dynamically source valuable information from nearby social media users.

In some aspects, controller 309 can receive event location data, determine a direction of movement of any individuals associated with event 320 (e.g., one or more citizens 340, other nearby citizens, one or more suspects (e.g., burglars, assailants, active shooters, etc.), and other potentially dangerous activities or situations based on the received event location data, determine, from database 314, one or more UAV response operations and related flight patterns, according to one or more criteria, and/or output the selected UAV response action to a UAV flight control system (e.g., a control system of UAV 270, a UAV base 280, a vehicle on which UAV 270 can dock, a command center, etc.) operable to cause one or more UAVs to perform a response operation (e.g., navigate to the alert location of event 320). The one or more criteria can include a UAV attendance profile with one or more intruder confrontation actions (e.g., distracting actions such as emitting distracting audio, flashing one or more LEDs, etc.), one or more observation actions (e.g., detecting an event of interest based on sensed audio feed, sensed video feed, observed changes in environment, etc.), and/or one or more aiding another UAV actions.

In some aspects, the one or more confrontation actions can include an action plan directing the UAV 270 to the alert location of event 320 and/or other area of interest (e.g., launching the UAV 270 from vehicle 330, a trunk, or elsewhere of a vehicle (e.g., from within the cabin via a moonroof and/or through a door window, from a location adjacent the vehicle, etc.), tracking and/or distracting a citizen or tracked suspect from further activity or to detain them) in collaboration with an onboard UAV controller 472 to oppose the determined direction of movement of the individual. In some aspects, the UAV attendance profile includes a flight plan directing the UAV 270 to a location of event 320 or other area of interest to follow a determined direction of movement of the individual. The UAV attendance profile can also include a collaborative flight plan directing the UAV to a location of event 320 or other area of interest associated with the one or more alerts in either aiding the other UAV (e.g., another UAV 270) or to replace a malfunctioning UAV 270 and connect to a command center or other system controller.

In some aspects, the flight plan output to UAV 270 can include instructions to deliver, when at or approximate to the area, one or more on-board effects such as distracting the intruder by emitting soundwaves such as sirens, frequencies in the electro-magnetic spectrum, and reception and onward transmission of data related to the one or more on-board effects. The flight plan output can also include launching a second UAV 270 in another threat response operation to alert people in the vicinity (e.g., a neighbor, a bystander, a police officer, etc.) regarding the detected threat. The flight plan output can also include UAV threat response operation includes launching another UAV 270 to track and identify the location of responding personnel (e.g., a police officer, ambulance, fire response unit, and/or other first responder in the vicinity), travel to the responding personnel, and/or guide the responding personnel to the event 320, any related person, and/or location of interest.

In operation, controller 309 can be configured to manage data streams from each corresponding UAV 270. Such data streams can be used by controller 309 to perform threat assessment logic so as to analyze and identify possible events arising to a predetermined threshold and initiate corresponding response actions in a distributed environment. Examples of such data streams can include audio feeds, video feeds, image feeds, related historical data, and any other feedback received from UAV 270 to identify events of interest (e.g., a conflict arising between a law enforcement officer and a citizen, an intruder breaking into a structure or a vehicle, a fire that is actively burning, an active shooter in a public setting, etc.). In some aspects, data processed by controller 309 can include a status feed of a nearby crowd-sourced data mesh (e.g., from database 233) to identify events of interest so as to identify and/or predict events of interest or threats based thereon.

In some aspects, data processed by controller 309 can include facial recognition data which can be used when implementing an example threat response flight operation by or through operations of UAV 270 to identify the intruder 220 (e.g., through facial recognition). In some embodiments, facial recognition may be performed by controller 309 and/or local computing systems of UAV 270. For example, the video, audio, and/or image data feeds from sensors 262 of UAV 270 as well as any other system sensors (e.g., sensors associated with “smart” city components) can be configured to transmit sensed respective data feeds to controller 309. Using threat assessment logic, controller 309 search and/or crawl connected databases (e.g., law enforcement facial recognition databases) and the internet generally to identify the suspected intruder. For example, controller 309 can search based on facial images of the suspected intruder as well as other potentially identifying information (e.g., voice recognition). Once a match is determined, a response flight operation of database 314 can be selected by controller 309.

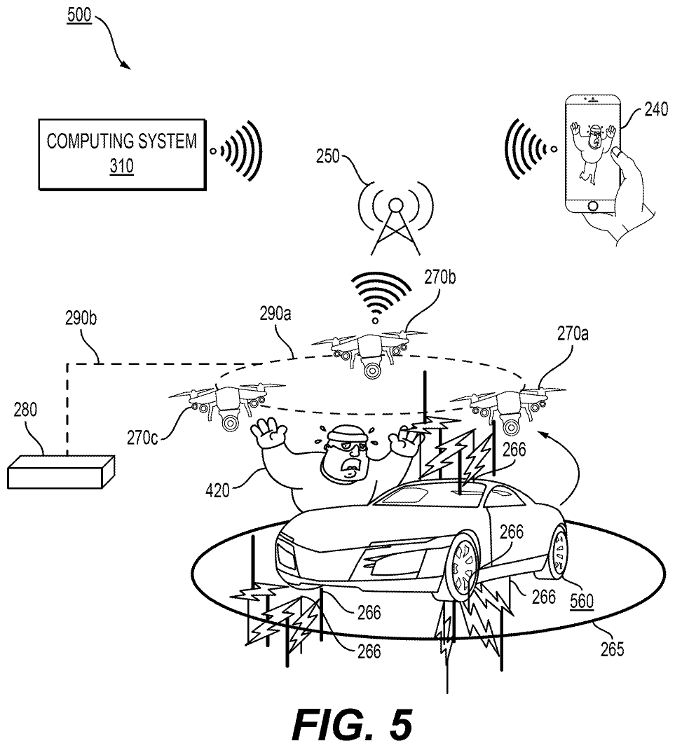

The database 314 can also include a predictive module based on the foregoing data feeds, historical data, and/or store one or more predetermined response flight operation plans operable to direct UAV 270 to respond to the detected threat sensed at area 265. Event database 316 can similarly include stored event types both to classify events based on determined matches. In some aspects, database 316 can include stored event types to also identify salient or otherwise anomalous events as well as events suitable for response by system 310. In some aspects, the selected flight plan can include a three-dimensional space defined by lateral and longitudinal distance ranges for one or more altitude ranges (e.g., see 290a, 290b of FIG. 5).

In some aspects, generator 312 is configured to classify, based on one or more data feeds including event type data and event location data related to event 320, event 320 according to characteristics that exceed a predetermined threshold, and then determine, based on the classification, one or more alerts and response actions based on the determined one or more event classifications. In some aspects, generator 312 is configured to analyze incoming data and select a UAV threat response operation from any herein discussed databases (e.g., databases 224, 228, 229, 231, 233, 314, 316, etc.), including database 314, to generate related alerts and response actions using one or more computing methods. Such methods can include, but are not limited to, statistical analysis, autonomous or machine learning, and AI. AI may include, but is not limited to, deep learning, neural networks, classifications, clustering, and regression algorithms. By using such computing methods, alert identification and analytics related to event type identification and/or appropriate response actions is substantially improved as is reliability and efficiency.

In some aspects, a computing system operating one or more of the foregoing computing methods can include a trained machine learning algorithm that takes, as input, any of the herein disclosed data feeds as well as historical databases (e.g., databases 224, 228, 229, 231, 233, 314, 316, facial recognition databases, crime feed databases related to the area associated with event 320, data feeds from vehicle 330, 342, or any other vehicles in the vicinity, data feeds from “smart” city components, etc.), and determines whether one or more salient events or trends are occurring and exceed a predetermined threshold according to event assessment logic. If exceeded, a response by system 310 and/or any corresponding UAVs 270 can be performed. Other historical databases for use can include available meteorological conditions, flight times/schedules of UAVs 270, a charge state of a power source, and/or a UAV tolerance to one or more meteorological conditions.

Many methods may be used to learn which aspects of the foregoing data feeds are salient to the extent one or more alerts are merited, including but not limited to: (1) weak supervision: training a machine learning system (e.g., multi-layer perceptron (MLP), convolutional neural network (CNN), graph neural network, support vector machine (SVM), random forest, etc.) using multiple instance learning (MIL) using weak labeling of the digital image or a collection of images; the label may correspond to the presence or absence of a salient areas; (2) bounding box or polygon-based supervision: training a machine learning system (e.g., region-based CNN (R-CNN), Faster R-CNN, Selective Search) using bounding boxes or polygons that specify the sub-regions of the digital image that are salient for the detection of the presence or absence of one or more markers related to a potential alert (3) pixel-level labeling (e.g., a semantic or instance segmentation): training a machine learning system (e.g., Mask R-CNN, U-Net, Fully Convolutional Neural Network); and/or (4) using a corresponding, but different digital image that identifies one or more alerts and/or response actions. In other aspects, such computing methods can also be used analyze the incoming data feeds and select a flight plan from the flight plan database based on the information pertaining to the one or more determined conditions and then output the selected flight plan to the one or more UAVs with determined readiness based on greatest amount of matching of the one or more conditions. In some aspects, based on determining the one or more alerts and/or response actions, such computing methods can also cause a flight control system of UAV 270 to navigate, within a predetermined threshold of time, to a location determined from the received one or more alerts.

In some aspects, generator 312 can generate an alert for transmission to UAV 270 as well as law enforcement, first responders, citizens in the vicinity, and/or one or more user devices 240 in response to an identification of an alert within the area of event 320. In some aspects, generator 312 can predict at least one event characteristic based on salient characteristics and/or trends identified in incoming data from any connected databases (e.g., databases 224, 228, 229, 231, 233, 314, 316, etc.). In some aspects, classifying event 320 can help to provide threat prediction(s) for the area associated event 320 and related responses. A machine learning model associated with generator 312 may have been generated by processing a plurality of training data to predict presence of at least one event characteristic, and the training data may be algorithmically generated based on incoming data from any connected databases (e.g., databases 224, 228, 229, 231, 233, 314, 316, etc.). In turn, generator 312, generator can be configured to be used to determine a predicted intruder, predicted event, and/or detected event which exceeds a predetermined threat assessment threshold.

For example, generator 312 may predict a future alert based on historical data and incoming data of the foregoing data feeds indicative of a severity or other characteristic satisfying a condition. The generator 312 may include a trained machine learning system having been trained using a learned set of parameters to predict event types, events, and/or intruders. In some embodiments, salient event data indicative of exceeding the predetermined threshold and thus meriting a response can include data indicating a time, a location, an event duration, an event type, and the like. In response to determining that event 320 exceeds the threshold according to threat assessment logic, generator 312 can generate a response, an alert, and/or notification (e.g., to UAV 270 and/or to user device 240) that indicates that a hazard is predicted to impact the equipment or other infrastructure and/or event. In some aspects, generator 312 transmitting the alert can cause, in addition to one or more threat response operations of UAV 270, additional responsive action to occur.

In some aspects, generator 312 can obtain event data from database 316 and then, based on one or more of the foregoing data feeds defining event type data, selectively determine whether to transmit an alert or determine a response associated with the event using the event type data. In some aspects, generator 312 can analyze the predetermined threshold of the threat assessment logic to determine whether the event merits further action based upon a total event score defined in part on the sensed event type data. If the score exceeds a threshold, only then can generator 312 take action such as transmitting a related alert and/or cause responsive action to be performed. The total score can be weighted depending on event type as well as environmental aspects such as current and/or predicted weather (e.g., whether a natural disaster is happening such as an earthquake, hurricane, tornado, or other such extreme event).

According to certain embodiments, system 310 may include a back-end including one or more servers. A server may perform various functions including UAV coordination, logic related to evaluation of data from associated data feeds (e.g., threat assessment logic), as well as storage/processing of captured data (e.g., audio feeds, video feeds, image feeds, etc.). In one example embodiment, the back-end architecture may include, or be in communication with, one or more of a database server, web server, stream server, and/or notify server. In some embodiments, this functionality may be split between multiple servers, which may be provided by one or more discrete providers. In an example embodiment, a web service for hosting computer applications or other cloud computing resource may be dynamically provisioned to match demand and ensure quality of service of system 310.

Referring to FIG. 5, another threat response system 500 is disclosed. System 500 is shown including one or more UAVs 270 used to protect personal property, such as a parked vehicle 260, from a suspected intruder 420. The driver and/or the owner of the vehicle 260 and/or a police officer are alerted (e.g., via a user device 240, an emitted sound or other perceptible output from one of the UAVs 270, etc.) of a suspected threat (e.g., suspected intruder 420) at or near a surveillance target (e.g., a parked automotive vehicle 260). Based on feedback from sensors 262 of UAVs 270, vehicle sensors 266, and any other remotely connected sensors (e.g., sensors of “smart” city components), as soon as the threat is detected, one or more UAVs 270 can be immediately launched to thwart the threat to avoid any theft or damage to the vehicle 260. In some aspects, a launched UAV 270 can be configured to identify the intruder 420, aerially chase after the intruder 420 while taking and transmitting event related data (e.g., live video, sound, and/or photos of the intruder 420) to private security, law enforcement including a law enforcement officer in the vicinity, a neighbor, drivers in the area, citizens in the area, and/or owner of the vehicle 260.

As an example of using multiple UAVs 270 in response to a detected threat, first UAV 270a can be launched in a response flight operation to identify intruder 420 (e.g., through facial recognition) and follow, track, and/or distract the intruder 420 from trying to harm or break into vehicle 260 (e.g., by emitting distracting audio such as a siren or a message announcing that peace officers have been notified, by flashing one or more LEDs, etc.). Second UAV 270b can be simultaneously launched in another response operation to similarly alert people in the vicinity (e.g., a neighbor, one or more citizens in the vicinity such as a bystander, a law enforcement officer, etc.), emitting distracting audio such as a siren or a message announcing that law enforcement officers have been notified, by flashing one or more LEDs, etc.), etc.) that a crime or some harmful event related to the detected threat is happening and to stay away or seek help. Third UAV 270c can be simultaneously launched in another response operation to track and identify the location of a law enforcement officer in the vicinity, travel to the officer, and/or guide the officer to vehicle 260 and/or intruder 420. In some aspects, all UAVs 270 can be in communications with one another to help assist in preventing the harm from happening to people and property and to direct the police officer to the intruder 420.

In some embodiments, control base 280 may be adjacent or otherwise nearby surveilled area 265 associated with vehicle 260. In some aspects, base 280 can be positioned in the surveilled area configured as a local control station for UAV 270 to control navigation of UAV 270 and communicate with system 310 (e.g., controller 309 of system 310) and one or more of plurality of UAVs 270 in a three-dimensional space. In this respect, base 280 can transmit to system 310 and/or UAV 270, data feeds (e.g., audio feeds, video feeds, image feeds, telemetry feeds, etc.) by way of a cloud-based controller server and/or remote computing device-based controller server. In some aspects, the one or more threat response operations can include any of the heretofore response operations. In some aspects, one threat response operation can include the UAV 270 following one or more predetermined routes 290a, 290b, . . . 290n, according to a flight plan database. In operation, the controller of system 310 is configured to receive information pertaining to one or more conditions determining readiness of UAV 270 and initiate one or more flight operations. For example, UAV 270 can be instructed to scan area 265 to verify presence of the suspected intruder 420 or other aspects of an alert. In one predetermined route 290a, UAV 270 can fly about surveilled area 265. In one predetermined route 290b, UAV 270 can surveil area 265 as well as fly to and from control base 280.

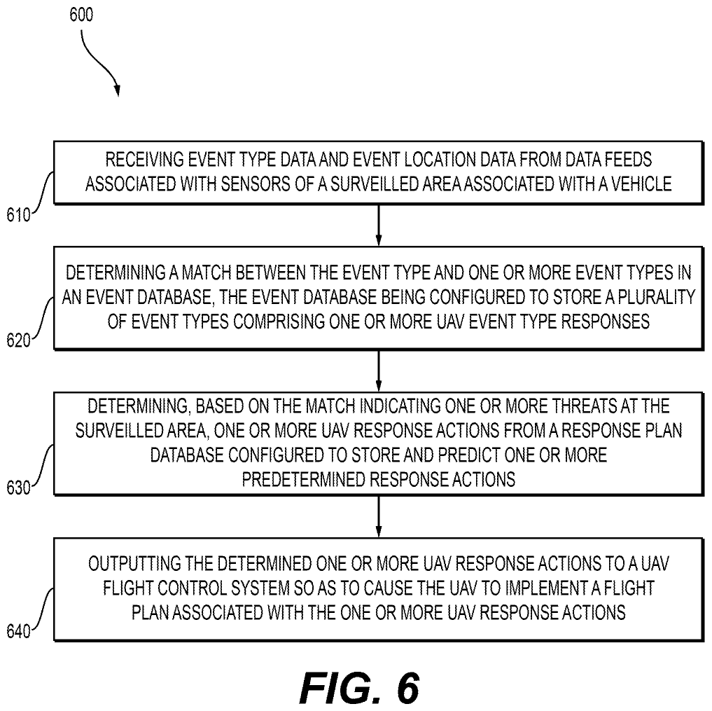

Referring to FIG. 6, a flow diagram of an example method 600 of operating a response system including one or more UAVs is illustrated where a threat at a surveilled area is detected. For example, method 600 (e.g., steps 610 to 640) may be performed automatically in response to the detected threat and/or in response to a request (e.g., from a user). In some aspects, a vehicle associated with the one or more UAVs can include sensors used to detect an intruder, any threat, or harm to the vehicle. In some aspects, such sensors can be used to predict the threat (e.g., based on historical data prior to it happening).

In step 610, the method may include receiving event type data and event location data from data feeds associated with sensors of a surveilled area associated with the vehicle or some other protectible property. In step 620, the method may include determining a match between the event type and one or more event types in an event database, the event database storing a plurality of event types including one or more UAV event type responses. For example, as soon as a threat is detected, one or more UAVs can be immediately launched. One event type response can include one or more UAVs can be launched from the vehicle and/or nearby base in response to detecting the threat. In some aspects, a detected threat event response can include one or more UAVs 270 launching from a trunk and/or elsewhere of the vehicle (e.g., from within the cabin via a moonroof and/or through a door window, from a location adjacent the vehicle, etc.). In step 630, the method may include determining, based on the match indicating one or more threats at the surveilled area, one or more UAV threat response operations from a response plan database configured to store and predict one or more predetermined response actions. In step 640, the method may include outputting the determined one or more UAV threat response operations to a UAV flight control system so as to cause the UAV to implement the one or more UAV threat response operations.

Some UAV threat response operations might include launching a first UAV to identify the intruder associated with the detected threat (e.g., through facial recognition) and follow, track, and/or distract the intruder from trying to harm or break into the vehicle. Another UAV threat response operation might include launching a second UAV in another threat response operation to similarly alert people in the vicinity (e.g., a neighbor, a bystander, a police officer, etc.) that a crime or some harmful event related to the detected threat is happening and to stay away or seek help. Another UAV threat response operation includes launching a third UAV to track and identify the location of a police officer in the vicinity, travel to the police officer, and/or guide the police officer to the vehicle and/or the intruder. All UAVs of the response system can be in communication with each other as well as a central controller to facilitate harm prevention by the intruder to the vehicle, other individuals, and nearby property as well as to coordinate with police officer(s) to the intruder.

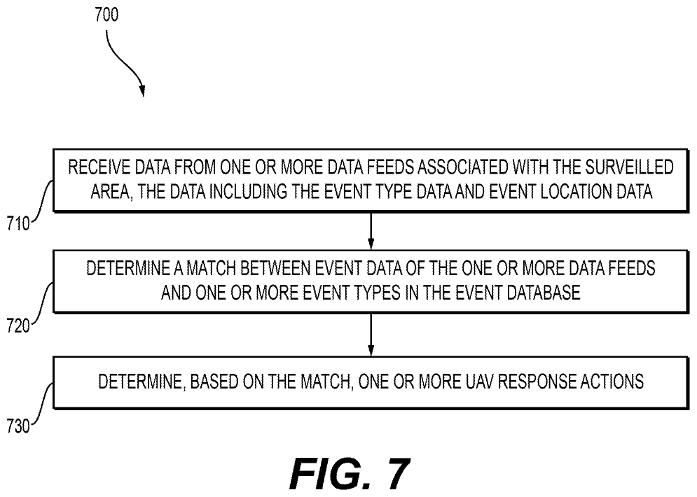

Referring to FIG. 7, a flow diagram of method 700 of operating a controller of a response system for one or more UAVs. For example, method 700 (e.g., steps 710 to 730) may be performed automatically or in response to a request (e.g., from a user). According to one embodiment, the exemplary method 700 may be implemented by a computing system such as a controller of any herein disclosed example that can perform operations of method 700 including one or more of the following steps. In step 710, the method may include receiving data from one or more data feeds associated with the surveilled area, the data including the event type data and event location data. In step 720, the method may include determining a match between event data of the one or more data feeds and one or more event types in the event database. In step 730, the method may include determining, based on the match, one or more UAV threat response operations. According to one or more embodiments, aspects of method 700 may utilize one or more algorithms, architectures, methodologies, attributes, and/or features that can be combined with any or all of the other algorithms, architectures, methodologies, attributes, and/or features. For example, any of the machine learning algorithms and/or architectures (e.g., neural network methods, convolutional neural networks (CNNs), recurrent neural networks (RNNs), etc.) may be trained with any of the training methodologies (e.g., Multiple Instance Learning, Reinforcement Learning, Active Learning, etc.). The description of these terms is merely exemplary and is not intended to limit the terms in any way.

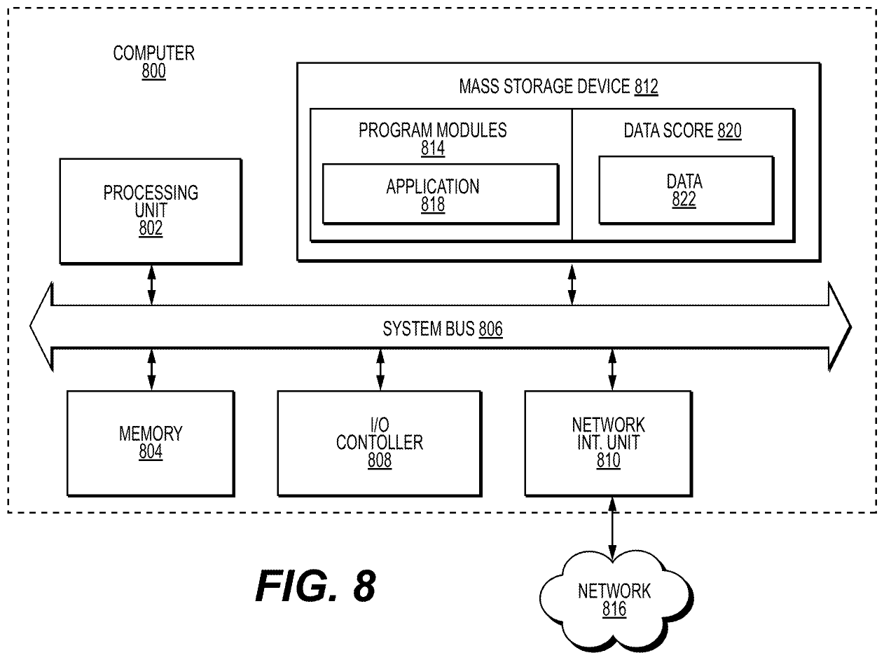

FIG. 8 is a computer architecture diagram showing a general computing system capable of implementing aspects of the present disclosure in accordance with one or more embodiments described herein, such as the computing system of UAV 270, base 280, and system 310. In any of these example implementations, computer 800 of the aforementioned may be configured to perform one or more functions associated with embodiments of this disclosure. For example, the computer 800 may be configured to perform operations in accordance with those examples shown in FIGS. 1 to 5. It should be appreciated that the computer 800 may be implemented within a single computing device or a computing system formed with multiple connected computing devices. The computer 800 may be configured to perform various distributed computing tasks, in which processing and/or storage resources may be distributed among the multiple devices. The data acquisition and display computer 850 and/or operator console 810 of the system shown in FIG. 8 may include one or more systems and components of the computer 800.

As shown, the computer 800 includes a processing unit 802 (“CPU”), a system memory 804, and a system bus 806 that couples the memory 804 to the CPU 802. The computer 800 further includes a mass storage device 812 for storing program modules 814. The program modules 814 may be operable to analyze data from any herein disclosed data feeds, determine responsive actions, and/or control any related operations (e.g., responsive actions by UAV 270 in response a determined threat at vehicle 260 of area 265). The program modules 814 may include an application 818 for performing data acquisition and/or processing functions as described herein, for example to acquire and/or process any of the herein discussed data feeds. The computer 800 can include a data store 820 for storing data that may include data 822 of data feeds (e.g., data from sensors 476).

The mass storage device 812 is connected to the CPU 802 through a mass storage controller (not shown) connected to the bus 806. The mass storage device 812 and its associated computer-storage media provide non-volatile storage for the computer 800. Although the description of computer-storage media contained herein refers to a mass storage device, such as a hard disk or CD-ROM drive, it should be appreciated by those skilled in the art that computer-storage media can be any available computer storage media that can be accessed by the computer 800.

By way of example and not limitation, computer storage media (also referred to herein as “computer-readable storage medium” or “computer-readable storage media”) may include volatile and non-volatile, removable and non-removable media implemented in any method or technology for storage of information such as computer-storage instructions, data structures, program modules, or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 800. “Computer storage media”, “computer-readable storage medium” or “computer-readable storage media” as described herein do not include transitory signals.

According to various embodiments, the computer 800 may operate in a networked environment using connections to other local or remote computers through a network 816 (e.g., previous network 350) via a network interface unit 810 connected to the bus 806. The network interface unit 810 may facilitate connection of the computing device inputs and outputs to one or more suitable networks and/or connections such as a local area network (LAN), a wide area network (WAN), the Internet, a cellular network, a radio frequency (RF) network, a Bluetooth-enabled network, a Wi-Fi enabled network, a satellite-based network, or other wired and/or wireless networks for communication with external devices and/or systems.

The computer 800 may also include an input/output controller 808 for receiving and processing input from any of a number of input devices. Input devices may include one or more of keyboards, mice, stylus, touchscreens, microphones, audio capturing devices, and image/video capturing devices. An end user may utilize the input devices to interact with a user interface, for example a graphical user interface, for managing various functions performed by the computer 800. The bus 806 may enable the processing unit 802 to read code and/or data to/from the mass storage device 812 or other computer-storage media.

The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer storage media may also represent secondary storage, whether implemented as hard drives or otherwise. Hard drive implementations may be characterized as solid state or may include rotating media storing magnetically-encoded information. The program modules 814, which include the data feed application 818, may include instructions that, when loaded into the processing unit 802 and executed, cause the computer 800 to provide functions associated with one or more embodiments illustrated in the figures of this disclosure. The program modules 814 may also provide various tools or techniques by which the computer 800 may participate within the overall systems or operating environments using the components, flows, and data structures discussed throughout this description.

In general, the program modules 814 may, when loaded into the processing unit 802 and executed, transform the processing unit 802 and the overall computer 800 from a general-purpose computing system into a special-purpose computing system. The processing unit 802 may be constructed from any number of transistors or other discrete circuit elements, which may individually or collectively assume any number of states. More specifically, the processing unit 802 may operate as a finite-state machine, in response to executable instructions contained within the program modules 814. These computer-executable instructions may transform the processing unit 802 by specifying how the processing unit 802 transitions between states, thereby transforming the transistors or other discrete hardware elements constituting the processing unit 802.

Encoding the program modules 814 may also transform the physical structure of the computer-storage media. The specific transformation of physical structure may depend on various factors, in different implementations of this description. Examples of such factors may include but are not limited to the technology used to implement the computer-storage media, whether the computer storage media are characterized as primary or secondary storage, and the like. For example, if the computer storage media are implemented as semiconductor-based memory, the program modules 814 may transform the physical state of the semiconductor memory, when the software is encoded therein. For example, the program modules 814 may transform the state of transistors, capacitors, or other discrete circuit elements constituting the semiconductor memory.

As another example, the computer storage media may be implemented using magnetic or optical technology. In such implementations, the program modules 814 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

According to certain embodiments, the above-described databases (e.g., databases 224, 228, 229, 231, 233, 314, 316, etc.) may be database servers that store master data, event related data, response plan data, telemetry information, and mission data as well as logging and trace information. The databases may also provide an API to the web server for data interchange based on JSON specifications. In some embodiments, the database may also directly interact with control systems of respective UAVs 270 to control flight operations. According to certain embodiments, the database servers may be optimally designed for storing large amounts of data, responding quickly to incoming requests, having a high availability and historizing master data.

According to certain embodiments, any of the systems of this disclosure may send notifications to a user (e.g., to device 240) including instant messages, SMS messages, and/or other electronic correspondence. If a predetermined condition evidencing a suspected or actual threat at an area (e.g., the area in or around event 320, area 265, etc.), an instant message may be triggered and delivered.

According to certain embodiments, UAVs 270 of this disclosure may automatically start and reschedule repetitive flight plans associated with respect to an area associated with an event of interest. For example, the system may include a scheduler module configured to observe status of each UAV 270, initiate any maintenance operations (e.g., return to a charging dock for charging, clear out cache of memory of UAV 270, update firmware of UAV 270, etc.).

In the description herein, numerous specific details are set forth. However, it is to be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the present disclosure so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form. Accordingly, “a drone” or “the drone” may refer to one or more drones where applicable.

Unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of the present disclosure may provide for a computer program product, including a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Various aspects described herein may be implemented using standard programming and/or engineering techniques to produce software, firmware, hardware, and/or any combination thereof to control a computing device to implement the disclosed subject matter. A computer-readable medium may include, for example: a magnetic storage device such as a hard disk, a floppy disk or a magnetic strip; an optical storage device such as a compact disk (CD) or digital versatile disk (DVD); a smart card; and a flash memory device such as a card, stick or key drive, or embedded component. Additionally, it should be appreciated that a carrier wave may be employed to carry computer-readable electronic data including those used in transmitting and receiving electronic data such as streaming video or in accessing a computer network such as the Internet or a local area network (LAN). Of course, a person of ordinary skill in the art will recognize many modifications may be made to this configuration without departing from the scope or spirit of the claimed subject matter.

While certain embodiments of the present disclosure have been described in connection with what is presently considered to be the most practical and various embodiments, it is to be understood that the present disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A threat response system for a vehicle, comprising:
a response and alert generator configured to classify an event by analyzing data from one or more data feeds comprising event type data and event location data related to a surveilled area, determine a total score of the event compared to a predetermined threat threshold, and output one or more response operations based on the event classification and the total score of the event;
a response plan database configured to store and/or predict one or more predetermined action plans operable to direct one or more unmanned aerial vehicle (UAVs) to respond to the event;
an event database configured to store a plurality of event types predetermined as suitable for a UAV response;
a controller configured to:
receive data from one or more data feeds associated with an event of the surveilled area, the data including the event type data and event location data;
classify the event by determining a match between a total score of the event compared with event data of the one or more data feeds and one or more event types in the event database;
determine, based on the match, one or more UAV response operations; and
cause the one or more UAVs to perform the one or more UAV response operations.

2. The system of claim 1, wherein the one or more UAV response operations comprise:
one or more UAVs launching from a law enforcement vehicle to identify a citizen or a suspect associated with the event;
causing the one or more UAVs to follow and/or distract the citizen or the suspect;
alerting, by the one or more UAVs, one or more persons in a vicinity of the event regarding the event; and
tracking and/or identifying, by the one or more UAVs, a location of a law enforcement officer in the vicinity of the event and/or guide the law enforcement officer to the event and/or the citizen or the suspect.

3. The system of claim 1, wherein the controller is configured to share the data with a local network based on a determined geolocation calculated from the event location data; and
use the local network as an information relay mesh that enhances communication of the one or more UAVs with a command center.

4. The system of claim 1, wherein the controller is configured to receive data from one or more sensors installed on one or more UAVs and/or the surveilled area, wherein data from the one or more sensors comprise a video feed, an audio data feed, a UAV location feed, a smart city component sensor feed, and a telemetry feed.

5. The system of claim 1, wherein the controller is configured to receive data from one or more sensors installed on one or more UAVs and/or the surveilled area, wherein data from the one or more sensors comprise a data feed of defined by data from one or more social media networks of user devices within a geofence associated with the event dynamically determined based on users with location-aware devices entering or exiting the geofence.

6. The system of claim 1, wherein the controller is configured to receive data from one or more sensors installed on one or more UAVs and/or the surveilled area, wherein data from the one or more sensors comprise a facial recognition data feed.

7. The system of claim 6, wherein the controller is configured to analyze event data of the one or more data feeds to determine the match by applying a machine learning system to identify one or more salient characteristics and apply a predictive score based on the classified event, the machine learning system having been generated by processing data from the one or more data feeds and data from the response plan database and the event plan database.

8. The system of claim 1, further comprising a database of a plurality of UAVs available for launch from a law enforcement vehicle and/or from one or more fixed city locations in a surrounding area of the surveilled area, and the event database and a flight plan database each store information pertaining to each UAV available for launch.

9. The system of claim 8, wherein the controller is configured to receive information pertaining to one or more conditions determining readiness of one or more UAVs of the plurality of UAVs for launch, wherein the controller, based on the match, is configured to:
launch a first UAV of the plurality of UAVs to identify an intruder associated with the event;
cause a second UAV of the plurality of UAVs to alert one or more persons in a vicinity regarding the event; and
cause a third UAV to track and identify a location of a law enforcement officer in the vicinity, travel to the law enforcement officer, and/or guide the law enforcement officer to the event and/or the intruder.

10. The system of claim 8, wherein the controller is configured to receive information pertaining to one or more conditions determining readiness of one or more UAVs of the plurality of UAVs for launch, wherein the one or more conditions include one or more of available UAV flight times, a charge state of a power source, and/or a UAV tolerance to one or more meteorological conditions.

11. The system of claim 8, wherein the controller is configured to receive information pertaining to one or more conditions determining readiness of one or more UAVs of the plurality of UAVs for launch, wherein the controller is configured to
select a flight plan from the flight plan database based on the information pertaining to the one or more meteorological conditions; and
output the selected flight plan to the one or more UAVs of the plurality of UAVs with determined readiness based on greatest amount of matching of the one or more conditions.

12. The system of claim 1, wherein the controller is configured to:
receive data from one or more sensors installed on one or more UAVs and/or the surveilled area, including configured one or more event location data;
determine a direction of movement of a suspected intruder based on the received one or more event location data and sensed characteristics of the suspected intruder;
determine, from the response plan database, one or more UAV response and flight patterns, according to criteria threat assessment of the suspected intruder; and/or
output the selected response plan to a UAV flight control system operable to allow multiple UAVs to navigate to one or more locations of the surveilled area.

13. The system of claim 12, wherein the one or more criteria comprises a UAV attendance profile comprising one or more confrontation actions, one or more observation actions, and/or one or more aiding another UAV actions.

14. The system of claim 13, wherein the one or more confrontation actions comprise an action plan directing one or more UAVs to the alert location in collaboration with an onboard UAV controller to oppose the determined direction of movement of the suspected intruder.

15. The system of claim 13, wherein the UAV attendance profile comprises a flight plan directing one or more UAVs to a location of the surveilled area associated with the one or more alerts to follow a determined direction of movement of the suspected intruder; and
wherein the flight plan output to the one or more UAVs further comprises instructions to deliver, when at or approximate to the location, one or more on-board effects comprising emissions of soundwaves, frequencies in the electro-magnetic spectrum, and reception and onward transmission of data related to the one or more on-board effects.

16. The system of claim 1, wherein the controller is configured to:
receive event related data from one or more sensors installed on one or more UAVs and/or the surveilled area; and
transmitting the event related data to one or more non-law tamper-resistant secure enforcement servers.

17. A method of operating a response system comprising one or more unmanned aerial vehicles (UAVs), the method comprising:
receiving event type data and event location data from data feeds associated with sensors of a surveilled area;
classifying an event of the surveilled area by determining a match between a total score of the event compared with event data of the one or more data feeds and one or more event types in the event database;
determining, based on the match, one or more UAV response operations from a response plan database configured to store and predict one or more predetermined response actions; and
outputting the determined one or more UAV response operations to a UAV flight control system so as to cause one or more UAVs to implement the one or more UAV response operations.

18. The method of claim 17, wherein the step of receiving event type data and event location data from data feeds comprises receiving data from one or more sensors installed on the one or more UAVs and/or the surveilled area, data from the one or more sensors comprising a data feed of defined by data from one or more social media networks of user devices within a geofence associated with the event dynamically determined based on users with location-aware devices entering or exiting the geofence.

19. The method of claim 17, wherein the one or more UAV threat response operations comprise:
launching one or more UAVs from a law enforcement vehicle to identify an intruder associated with the event;
causing the one or more UAVs to follow and/or distract the intruder;
alerting, by the one or more UAVs, one or more persons in a vicinity of the intruder regarding the event and the intruder; and
tracking and/or identifying, by the one or more UAVs, a location of a responding officer in the vicinity.

20. A non-transitory computer-readable medium storing instructions that, when executed by a processor to perform a method, the method comprising:
receiving event type data and event location data from data feeds associated with sensors of a surveilled area;
classifying an event of the surveilled area by determining a match between a total score of the event compared with event data of the one or more data feeds and one or more event types in the event database;
determining, based on the match, one or more UAV response operations from a response plan database configured to store and predict one or more predetermined response actions; and
outputting the determined one or more UAV response operations to a UAV flight control system so as to cause one or more UAVs to implement the one or more UAV response operations.
